(19) United States
(12) Patent Application Publication
(10) Pub. No.: US 2025/0389605 A1
(43) Pub. Date: Dec. 25, 2025

(54) PRESSURE SENSOR AND ELECTRONIC EQUIPMENT

(71) Applicant: Murata Manufacturing Co., Ltd., Nagaokakyo-shi (JP)

(72) Inventors: Yoshihiro YOSHIDA, Nagaokakyo-shi (JP); Mami UCHIDA, Nagaokakyo-shi (JP)

(21) Appl. No.: 19/317,476

(22) Filed: Sep. 3, 2025

Related U.S. Application Data
(63) Continuation of application No. PCT/JP2024/007859, filed on Mar. 1, 2024.

(30) Foreign Application Priority Data
Apr. 17, 2023 (JP) 2023-067081

(51) Int. Cl. G01L 19/14

(52) U.S. Cl. CPC G01L 19/143

(57) ABSTRACT

A pressure sensor that includes a substrate; a detection element on the substrate; and a covering member on the substrate and defining an exposure hole that exposes at least part of the detection element to an outside, and covering the detection element by a portion excluding the exposure hole. The covering member having: a main body having an upper surface on the opposite side to a surface thereof facing the substrate, and a protrusion that protrudes from the upper surface of the main body and through which the exposure hole extends. The main body has at least one recess in the upper surface along the protrusion in a plan view as viewed in the thickness direction of the substrate and that hollows along the thickness direction. The at least one recess extends around at least part of the protrusion in a circumferential direction thereof in the plan view.

### CROSS REFERENCE TO RELATED APPLICATIONS

The present application is a continuation of International application No. PCT/JP2024/007859, filed Mar. 1, 2024, which claims priority to Japanese Patent Application No. 2023-067081, filed Apr. 17, 2023, the entire contents of each of which are incorporated herein by reference.

### TECHNICAL FIELD

The present disclosure relates to a pressure sensor formed by using a micro-electro-mechanical systems (MEMS) technology and electronic equipment on which this pressure sensor is mounted.

### BACKGROUND ART

Hitherto, as this kind of pressure sensor, for example, a pressure sensor described in Patent Document 1 is known. The pressure sensor described in Patent Document 1 includes a base member, a detection element disposed on the base member, and a resin package disposed on the base member to cover the detection element. An exposure hole that exposes at least part of the detection element is made in the resin package.

The resin package has a main portion that is disposed on the base member and has a rectangular parallelepiped shape and a columnar ring holding portion extending from the upper surface of the main portion in a direction away from the base member. The exposure hole is formed to open at a top portion of the ring holding portion and extend toward the base member.
Patent Document 1: U.S. Patent Application Publication No. 2022/0190230

### SUMMARY OF THE DISCLOSURE

There is still room for improvement in the pressure sensor of Patent Document 1 in terms of suppressing a defect in attachment of the pressure sensor to a casing while keeping the waterproof performance.

Therefore, an object of the present disclosure is to solve the above-described problem, and is to provide a pressure sensor for which a defect in attachment to a casing is suppressed while the waterproof performance is kept.

A pressure sensor according to the present disclosure includes: a substrate; a detection element on the substrate; and a covering member on the substrate and defining an exposure hole that exposes at least part of the detection element to an outside, the covering member covering the detection element by a portion excluding the exposure hole, the covering member having: a main body having an upper surface on an opposite side to a surface thereof facing the substrate, and a protrusion that protrudes from the upper surface of the main body, the exposure hole extending through the protrusion, the main body having at least one recess in the upper surface along the protrusion in a plan view as viewed in a thickness direction of the substrate and that hollows along the thickness direction, and the at least one recess extends around at least part of the protrusion in a circumferential direction of the protrusion in the plan view.

According to the present disclosure, it is possible to provide the pressure sensor for which a defect in attachment to a casing is suppressed while the waterproof performance is kept.

### BRIEF DESCRIPTION OF THE DRAWINGS

FIG. 1 is a plan view of a pressure sensor according to a first embodiment of the present disclosure.

FIG. 2 is a sectional view of the pressure sensor of FIG. 1 along line II-II.

FIG. 3 is a sectional view of the pressure sensor of FIG. 1 along line III-III.

FIG. 4 is an enlarged sectional view of region EA1 of the pressure sensor of FIG. 3.

FIG. 5 is a sectional view depicting electronic equipment according to the first embodiment of the present disclosure, and is a diagram corresponding to line II-II in FIG. 1.

FIG. 6 is a sectional view depicting the electronic equipment according to the first embodiment of the present disclosure, and is a diagram corresponding to line III-III in FIG. 1.

FIG. 7 is a plan view depicting a modification of the pressure sensor of FIG. 1.

FIG. 8 is a sectional view depicting electronic equipment having the pressure sensor of FIG. 7, and is a diagram corresponding to line VIII-VIII in FIG. 7.

FIG. 9 is a plan view of a pressure sensor according to a second embodiment of the present disclosure.

FIG. 10 is a sectional view of the pressure sensor of FIG. 9 along line X-X.

### DESCRIPTION OF THE PREFERRED EMBODIMENTS

An existing pressure sensor (for example, pressure sensor described in Patent Document 1) is attached to, for example, a casing in which a casing recess that receives the ring holding portion is made. At the time of attachment of the pressure sensor, an O-ring is disposed around the ring holding portion. In a state in which the pressure sensor is attached to the casing, the O-ring is located in a disposition space for the O-ring surrounded by the upper surface of the main portion, the outer circumferential surface of the ring holding portion, and the inner surface of the casing recess. In the disposition space, the O-ring is in contact with the surface of the resin package and the inner surface of the casing recess. The intrusion of a liquid into the inside of the resin package is suppressed by the contact with these surfaces.

However, with the configuration of the existing pressure sensor, the capacity of the above-described disposition space and the volume of the O-ring change due to manufacturing tolerances of the resin package, the casing, and the O-ring. Thus, there is a fear that the filling rate of the O-ring in the disposition space becomes excessive.

When the filling rate of the O-ring is excessive, possibly the O-ring is strongly squeezed in a lateral direction between the outer circumferential surface of the ring holding portion and the inner wall surface of the casing recess and is deformed to a large extent in the extension direction of the ring holding portion (vertical direction). In this case, there is a fear that insertion of the ring holding portion into the casing recess is inhibited by the O-ring and a defect in attachment of the pressure sensor occurs.

It is conceivable that the disposition space for the O-ring is designed to be larger and that the O-ring is made smaller as measures for restraining the filling rate of the O-ring from becoming excessive. However, with these measures, there is a fear that the contact between the O-ring and the resin package and the casing recess becomes difficult and the waterproof performance lowers.

Thus, the present inventors have actively considered in order to suppress a defect in attachment of the pressure sensor to the casing while keeping the waterproof performance. As a result, the present inventors have found a configuration of a pressure sensor in which an evacuation space for evacuating part of the O-ring from the disposition space is made. When the pressure sensor is attached, the O-ring enters the evacuation space depending on the magnitude of pressing from the resin package and the casing. Thus, it is possible to restrain the filling rate of the O-ring from becoming excessive while keeping the waterproof performance. The present inventors have reached the following disclosure on the basis of this novel knowledge.

Embodiments of the present disclosure are described below with reference to the drawings. In the following description, terms indicating a specific direction or position (for example, terms including “upper,” “lower,” “right,” or “left”) are used as required. The purpose of using these terms is to facilitate understanding of the present disclosure with reference to the drawings, and the technical scope of the present disclosure is not limited by meanings of these terms. Further, the following description is merely an example essentially, and does not intend to limit the present disclosure, a matter to which the present disclosure is applied, or use of the present disclosure.

In the present specification, an expression “electrically connect” includes all of a state in which a current can be conducted between a plurality of constituent elements, a state in which a plurality of constituent elements are capacitively coupled, and a state in which a plurality of constituent elements are electromagnetically coupled.

### First Embodiment

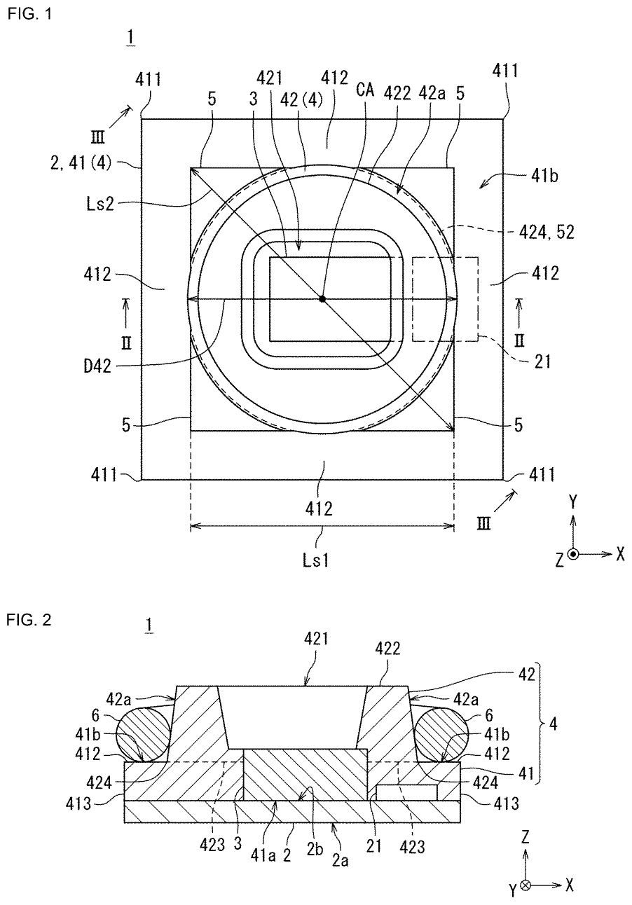

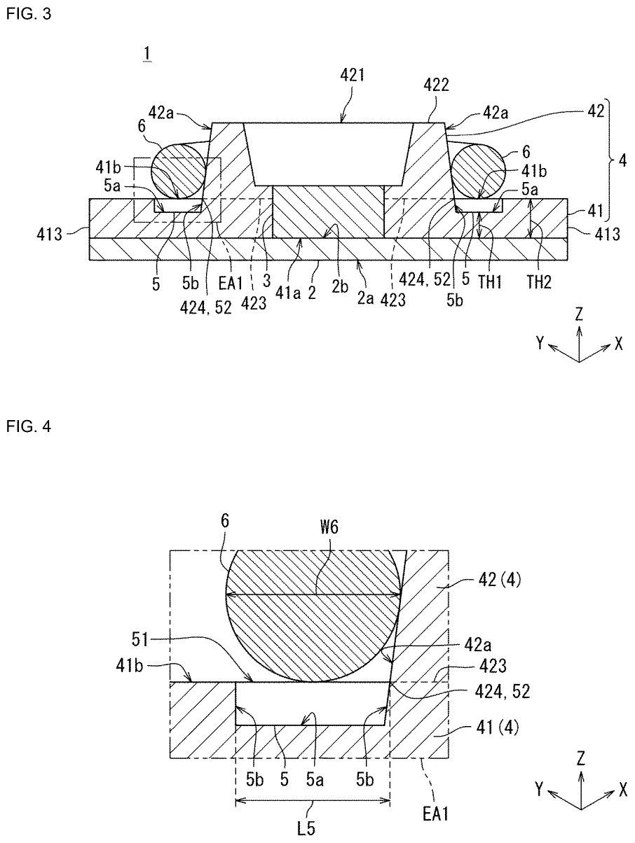

A pressure sensor according to a first embodiment of the present disclosure is described with reference to FIGS. 1 to 3. FIG. 1 is a plan view of the pressure sensor according to the first embodiment of the present disclosure. FIG. 2 is a sectional view of the pressure sensor of FIG. 1 along line II-II. FIG. 3 is a sectional view of the pressure sensor of FIG. 1 along line III-III. An O-ring 6 to be described later is depicted in FIG. 2 and FIGS. 3 to 6, 8, and 10 to be described later. Although an X-Y-Z Cartesian coordinate system is depicted in the drawings for convenience of description, this coordinate system is to make understanding of the present disclosure easy, and does not limit the disclosure.

As depicted in FIGS. 1 to 3, a pressure sensor 1 includes a substrate 2, a detection element 3 disposed on the substrate 2, and a covering member 4 disposed on the substrate 2 to cover the detection element 3. Pressures measured by the pressure sensor 1 include an absolute pressure, a gauge pressure, a differential pressure, the pressure of a gas flow, and the like.

As depicted in FIG. 2, the substrate 2 has a lower surface 2a and an upper surface 2b on the opposite side to the lower surface 2a. For example, the substrate 2 is a wiring board of a ceramic substrate, a resin substrate, or the like or a lead frame. A Z-axis direction is an example of “thickness direction of the substrate” in the present disclosure. As depicted in FIG. 1, in the present embodiment, the substrate 2 has a square shape having sides extending along an X-axis direction or a Y-axis direction in plan view as viewed in the Z-direction.

The detection element 3 and a circuit element 21 are disposed on the substrate 2. The detection element 3 is a pressure sensor element that detects a pressure. For example, the detection element 3 is a pressure sensor element of a piezo-resistive type or an electrostatic capacity type, and is a micro-electro-mechanical systems (MEMS) element. For example, the circuit element 21 is an element including an application specific integrated circuit (ASIC). In the present embodiment, the circuit element 21 includes a converter that converts a voltage signal output from the detection element 3 to a digital signal, a filter that executes filtering for the digital signal from the converter, a temperature sensor that detects a temperature, a processor that corrects the digital signal resulting from the filtering on the basis of the temperature detected by the temperature sensor, a memory that stores a correction coefficient used when the digital signal is corrected by using the detected temperature, etc., and the like.

As depicted in FIG. 2, in the present embodiment, the detection element 3 and the circuit element 21 are disposed side by side on the upper surface 2b of the substrate 2. For example, each of the detection element 3 and the circuit element 21 is bonded to the substrate 2, with an adhesive member such as a die attach film or a die bonding material interposed therebetween. The detection element 3 and the circuit element 21 are electrically connected. In the present embodiment, the detection element 3 and the circuit element 21 are electrically connected by bonding wire (not depicted) that connects them.

The detection element 3 and the circuit element 21 may be electrically connected through a circuit of the substrate 2. For example, each of the detection element 3 and the circuit element 21 may be connected to the circuit of the substrate 2 through wire bonding or a bump. Moreover, the detection element 3 and the circuit element 21 may be disposed to overlap in the Z-direction over the upper surface 2b of the substrate 2.

The covering member 4 is disposed on the upper surface 2b of the substrate 2, and covers part of the detection element 3, the circuit element 21, and the wire bonding. The covering member 4 has a main body 41 having a lower surface 41a facing the substrate 2 and an upper surface 41b on the opposite side to the lower surface 41a, and a protrusion 42 extending in the positive direction of the Z-axis from the upper surface 41b of the main body 41. The boundary between the main body 41 and the protrusion 42 is indicated by a dashed line in FIG. 2 and FIGS. 3 to 6, 8, and 10 to be described later.

For example, each of the main body 41 and the protrusion 42 has a circular shape, an elliptical shape, a polygonal shape, or the like in plan view. In the present embodiment, as depicted in FIG. 1, the main body 41 has a rectangular shape having four corner portions 411 in plan view. Specifically, the main body 41 is disposed on the whole of the upper surface 2b of the substrate 2, and has a square shape in plan view. The protrusion 42 has a circular shape in plan view. As depicted in FIG. 2, the protrusion 42 is formed into a tapered shape that gradually becomes thinner in the positive direction of the Z-axis, and has a top portion 422. The protrusion 42 has an outer wall surface 42a that connects the top portion 422 to the upper surface 41b of the main body 41. That is, in the present embodiment, the protrusion 42 is formed into a circular truncated cone shape.

An exposure hole 421 that exposes at least part of the detection element 3 to the outside is made in the protrusion 42. In the present embodiment, the exposure hole 421 extends along the Z-direction, and opens in the top portion 422. Thus, the covering member 4 covers the detection element 3 by a portion excluding the exposure hole 421. In the present embodiment, the covering member 4 seals and protects part of the detection element 3, the circuit element 21, and the wire bonding.

For example, the covering member 4 is formed by transfer molding using two molds. A collective board in which a large number of substrates 2 are arranged in the plane direction is prepared on one mold. The other mold has a shape corresponding to the outer shape of the covering member 4, and is disposed such that the collective board is interposed between the one mold and the other mold. A space between the collective board and the other mold is filled with a resin. This forms the covering member 4 for the large number of substrates 2. Further, a film assisted molding (FAM) process in which a mold release film is disposed on the other mold may be executed.

As depicted in FIG. 1, the main body 41 has at least one recess 5 made in the upper surface 41b along the protrusion 42 in plan view. As depicted in FIG. 3, each recess 5 hollows along the Z-direction. As depicted in FIG. 1, the recess 5 is made around at least part of the protrusion 42 in the circumferential direction thereof in plan view.

In the first embodiment, the main body 41 has four recesses 5 made around only part of the protrusion 42 in the circumferential direction thereof in plan view. That is, the upper surface 41b of the main body 41 has a non-recess region 412 that is adjacent to the protrusion 42 and in which the recess 5 is not made. That is, the recess 5 is not made around the whole circumference of the protrusion 42.

Specifically, the four recesses 5 are formed at a portion obtained by excluding the region of the protrusion 42 from a virtual square on the upper surface 41b of the main body 41 in plan view. This virtual square has two sides extending along the X-axis direction and two sides extending along the Y-axis direction. Further, the center of the virtual square corresponds with a virtual central axis CA of the substrate 2 and the main body 41 in plan view. A length Ls1 of one side of the virtual square is shorter than a diameter D42 of the protrusion 42. Moreover, a length Ls2 of the diagonal of the virtual square is longer than the diameter D42 of the protrusion 42.

In the present embodiment, the four recesses 5 are formed to be congruent in plan view. Further, each one of the four recesses 5 is made between a respective one of the corner portions 411 of the main body 41 and the protrusion 42 in plan view. The expression “between the corner portion 411 and the protrusion 42” used here refers to, for example, a region including a line that couples the corner portion 411 and the virtual central axis CA of the protrusion 42 in plan view. In the present embodiment, the four recesses 5 are made at equal intervals in the circumferential direction of the protrusion 42 in plan view. Meanwhile, the non-recess region 412 is disposed between adjacent two of the four recesses 5 in the circumferential direction of the protrusion 42.

FIG. 4 is an enlarged sectional view of region EA1 of the pressure sensor of FIG. 3. As depicted in FIG. 4, the recess 5 has a bottom surface 5a. The bottom surface 5a of the recess 5 is connected to the upper surface 41b of the main body 41 or the outer wall surface 42a of the protrusion 42 by an inner wall surface 5b. In the present specification, a description is given on the basis of an assumption that the upper surface 41b of the main body 41 does not include the bottom surface 5a and the inner wall surface 5b of the recess 5 but include a virtual opening surface of the recess 5.

An outer edge 424 of a lower end 423 of the protrusion 42 forms an edge 52 of an opening 51 of the recess 5. Thus, the outer wall surface 42a of the protrusion 42 and the inner wall surface 5b of the recess 5 are formed as a continuous surface along the Z-direction. In the present embodiment, the outer wall surface 42a of the protrusion 42 and the inner wall surface 5b of the recess 5 are formed to be flush with each other.

As depicted in FIG. 3, at the portion at which the recess 5 is formed, the main body 41 has a thickness TH1 between the lower surface 41a of the main body 41 and the bottom surface 5a of the recess 5. Further, the main body 41 has a thickness TH2 between the lower surface 41a of the main body 41 and the upper surface 41b between an outer edge portion 413 of the main body 41 and the recess 5 in the plane direction intersecting (for example, orthogonal to) the Z-direction. The thickness TH2 is larger than the thickness TH1.

Due to disposing the portion thicker than the thickness TH1 between the outer edge portion 413 of the main body 41 and the recess 5, it becomes easy to supply the resin to the whole of the collective board in the plane direction in the above-described transfer molding compared with a configuration in which this thicker portion is absent.

As depicted in FIG. 3, the pressure sensor 1 may be further provided with the O-ring 6 that surrounds the protrusion 42 in plan view and is in contact with the outer wall surface 42a of the protrusion 42. For example, the O-ring 6 is formed of an elastic member, and has a circular or substantially circular section. In the present embodiment, the O-ring 6 has an inner diameter smaller than the diameter of the outer edge 424 of the protrusion 42 (see FIG. 1). Thus, the O-ring 6 is disposed near the lower end 423 of the protrusion 42 in a state in which the O-ring 6 is elastically deformed, and is in contact with the outer wall surface 42a of the protrusion 42 across the whole circumference.

As depicted in FIG. 4, a length L5 of at least part of the recess 5 in the direction parallel to the width of the O-ring 6 is shorter than a width W6 of the O-ring 6. For example, the width W6 of the O-ring 6 is measured in a state in which the pressure sensor 1 is not attached to a casing 7 to be described later. In the present embodiment, the O-ring 6 has a circular shape in plan view because being in contact with the outer wall surface 42a of the protrusion 42 across the whole circumference. Thus, the length L5 of the recess 5 is measured in the radiation direction from the virtual central axis CA.

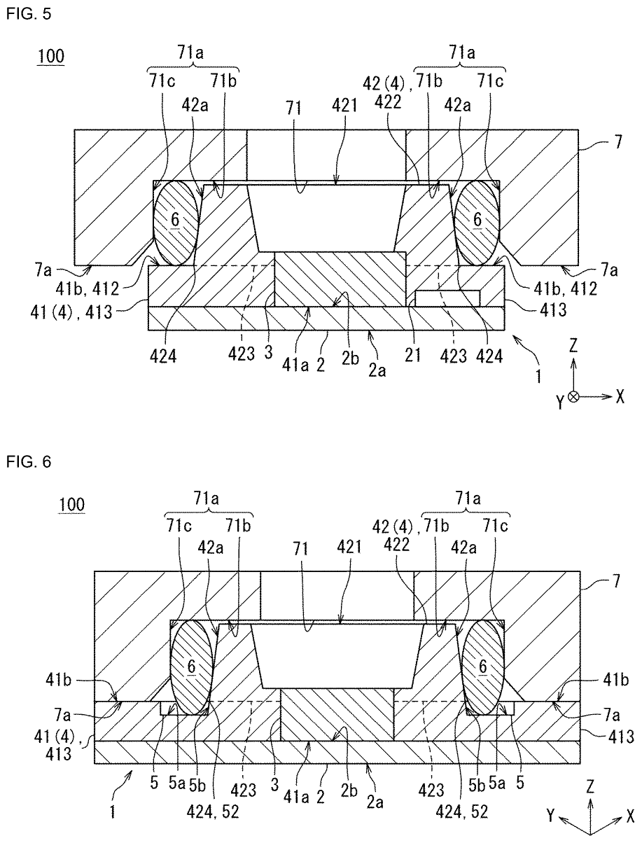

Attachment of the pressure sensor 1 to the casing 7 is described with reference to FIGS. 5 and 6. FIG. 5 is a sectional view depicting electronic equipment according to the first embodiment of the present disclosure, and is a diagram corresponding to line II-II in FIG. 1. FIG. 6 is a sectional view depicting the electronic equipment according to the first embodiment of the present disclosure, and is a diagram corresponding to line III-III in FIG. 1.

The casing 7 is, for example, a casing of the electronic equipment on which the pressure sensor 1 is mounted. As depicted in FIG. 6, in the casing 7, a casing recess 71 that receives the protrusion 42 when the pressure sensor 1 is attached to the casing 7 is made. In the example depicted in FIG. 6, the casing recess 71 hollows from a top surface 7a of the casing 7. The casing recess 71 has an inner surface 71a including a bottom surface 71b and an inner wall surface 71c. The inner wall surface 71c connects the bottom surface 71b of the casing recess 71 to the top surface 7a of the casing 7 along the Z-direction.

The casing recess 71 is configured to form a space surrounded by the outer wall surface 42a of the protrusion 42, the bottom surface 71b of the casing recess 71, and the inner wall surface 71c of the casing recess 71 when the protrusion 42 is inserted into the casing recess 71. This space is a space in which the O-ring is disposed at the time of attachment of the pressure sensor 1 to the casing 7 (hereinafter, referred to also as disposition space).

When the pressure sensor 1 is attached to the casing 7, the pressure sensor 1 approaches the casing 7 along the Z-direction such that the protrusion 42 is inserted into the casing recess 71. In the process of this approach, the O-ring 6 comes into contact with the inner wall surface 71c of the casing recess 71 earlier than with the bottom surface 71b of the casing recess 71. Thus, the O-ring 6 is pressed to be elastically deformed in the width direction of the O-ring 6 by the protrusion 42 and the casing 7. In this elastic deformation, the dimension of the O-ring 6 in the width direction becomes smaller, and the dimension of the O-ring 6 in the height direction (that is, Z-direction) becomes larger.

When the pressure sensor 1 further approaches the casing 7, the O-ring 6 comes into contact with the bottom surface 71b of the casing recess 71. At this time, in a case in which the filling rate of the O-ring 6 in the above-described disposition space becomes excessive, part of the O-ring 6 is pressed by the protrusion 42 and the casing 7 and enters the recesses 5 (see FIG. 6). That is, the recesses 5 function as an evacuation space for the O-ring 6 in the case in which the filling rate of the O-ring 6 becomes excessive in the attachment of the pressure sensor 1 to the casing 7. This can restrain the filling rate of the O-ring 6 from becoming excessive in the region in which the recess 5 is made (see FIG. 6).

In association with the entry of part of the O-ring 6 into the recesses 5, portions disposed on the non-recess region 412 (see FIG. 1) of the main body 41 in the O-ring 6 are pulled toward the adjacent recesses 5. Thus, the portions disposed on the non-recess region 412 in the O-ring 6 are pulled in the circumferential direction of the O-ring 6 and are elastically deformed. Due to this elastic deformation, the sectional area of the O-ring 6 decreases over the non-recess region 412 as depicted in FIG. 5. This can restrain the filling rate of the O-ring 6 from becoming excessive also in the non-recess region 412 (see FIG. 5).

The pressure sensor 1 is disposed at a predetermined position with respect to the casing 7, and thereupon the attachment of the pressure sensor 1 is completed. This forms electronic equipment 100 including the pressure sensor 1 and the casing 7. In the electronic equipment 100, part of the O-ring 6 is located in the recesses 5. Due to this, it is also possible to restrain the O-ring 6 from being dislocated in the plane direction intersecting the Z-direction and deviating from the disposition space. In the present embodiment, in the electronic equipment 100, the top surface 7a of the casing 7 is in contact with the upper surface 41b of the main body 41 of the pressure sensor 1.

### Modification

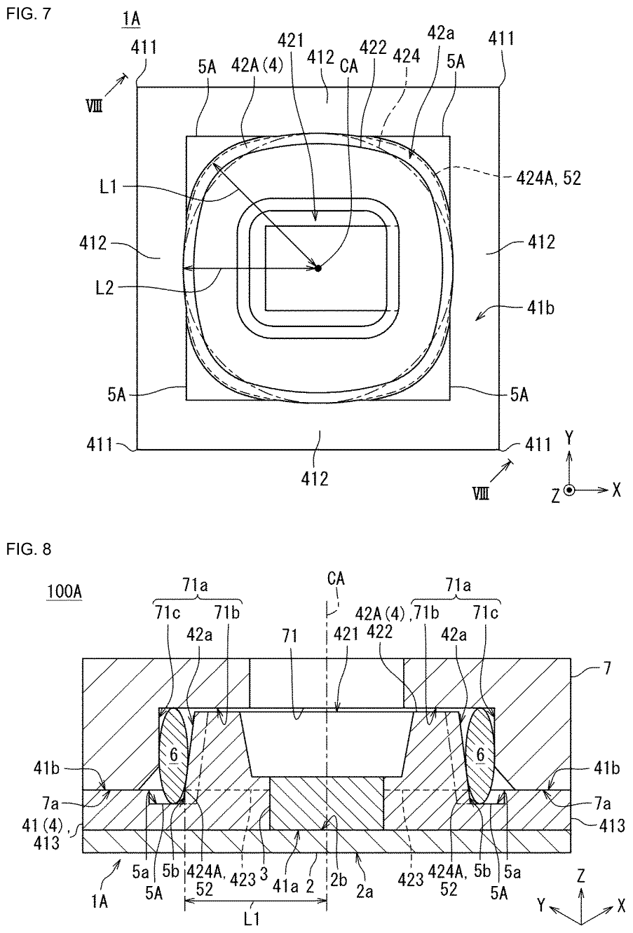

A modification of the pressure sensor according to the first embodiment is described with reference to FIGS. 7 to 8. FIG. 7 is a plan view depicting the modification of the pressure sensor of FIG. 1. FIG. 8 is a sectional view depicting electronic equipment having the pressure sensor of FIG. 7, and is a diagram corresponding to line VIII-VIII in FIG. 7. In FIG. 7, the outer edge 424 of the lower end 423 of the protrusion 42 in the pressure sensor 1 according to the first embodiment is indicated by a dashed-dotted line. In FIG. 8, the protrusion 42 and the recesses 5 in the pressure sensor 1 according to the first embodiment are indicated by dashed-dotted lines. In the following description of the modification, description is omitted concerning a configuration similar to that in the above-described first embodiment.

In a pressure sensor 1A of the modification depicted in FIG. 7, a protrusion 42A has a circular shape in plan view, and is enlarged toward each corner portion 411 along the extension direction of the diagonal that couples the corner portions 411. The protrusion 42A has an outer edge 424A of the lower end 423. The protrusion 42A has a distance L1 between the outer edge 424A adjacent to a recess 5A and the virtual central axis CA. Further, the protrusion 42A has a distance L2 between the outer edge 424A of the lower end 423 adjacent to the non-recess region 412 and the virtual central axis CA. The distance L1 is longer than the distance L2.

As depicted in FIG. 8, the pressure sensor 1A forms electronic equipment 100A by being attached to the casing 7. Due to the enlargement of the protrusion 42A, each recess 5A is smaller than each recess 5 in the first embodiment in plan view. Moreover, in the electronic equipment 100A, the disposition space for the O-ring 6 is smaller than that in the electronic equipment 100 according to the first embodiment.

Due to the size reduction of the disposition space for the O-ring 6, the O-ring 6 can be more surely brought into contact with the bottom surface 71b of the casing recess 71 in the electronic equipment 100A. Therefore, the lowering of the waterproof performance of the electronic equipment 100A can be suppressed.

In the pressure sensor 1 according to the first embodiment, in attachment of the pressure sensor 1 to the casing 7, the O-ring 6 pressed by the covering member 4 and the casing 7 can enter the inside of the recesses 5 when the filling rate of the O-ring 6 in the disposition space for the O-ring 6 becomes high. Thus, the O-ring 6 compressed by the outer wall surface 42a of the protrusion 42 and the inner wall surface 71c of the casing recess 71 can be restrained from existing on the upper side far beyond the top portion 422 of the protrusion 42. This reduces the likelihood of inhibition of attachment of the pressure sensor 1 due to the O-ring 6. Thus, it becomes easy for the pressure sensor 1 to be disposed at a correct position with respect to the casing 7. That is, a defect in attachment of the pressure sensor 1 to the casing 7 can be suppressed.

Further, in the pressure sensor 1 according to the first embodiment, the outer edge 424 of the lower end 423 of the protrusion 42 forms the edges 52 of the openings 51 of the recesses 5. Thus, the outer wall surface 42a of the protrusion 42 and the inner wall surfaces 5b of the recesses 5 form continuous surfaces along the Z-direction. Due to this, compared with a configuration in which the outer edge 424 of the lower end 423 of the protrusion 42 does not form the edges 52 of the openings 51 of the recesses 5, the O-ring 6 can easily enter the inside of the recesses 5 when being pressed by the outer wall surface 42a of the protrusion 42 and the inner surface 71a of the casing recess 71. Therefore, the likelihood of inhibition of attachment of the pressure sensor 1 due to the O-ring 6 is further reduced. Thus, a defect in attachment of the pressure sensor 1 to the casing 7 can be further suppressed.

Moreover, in the pressure sensor 1 according to the first embodiment, at least one recess 5 is made around part of the protrusion 42 in the circumferential direction thereof in plan view. In other words, the recess 5 is not made at the remaining part in the circumferential direction. In the non-recess region 412, the disposition space is smaller than that at the part at which the recess 5 is made, and thus an upper portion of the O-ring 6 easily comes into contact with the bottom surface 71b of the casing recess 71. Due to this, even when the filling rate of the O-ring 6 is low, the waterproof performance of the pressure sensor 1 is easily kept compared with a configuration in which the recess 5 is made around the whole circumference of the protrusion 42.

Further, part of the O-ring 6 is located in the recesses 5 each having two end portions (that is, the recesses 5 do not have an annular shape) in the state in which the pressure sensor 1 is attached to the casing 7. At this time, it is difficult for the portion located in the recess 5 in the O-ring 6 to rise to the outside of the recess 5 at the end portion. In addition, conversely, it is also difficult for the portion located on the non-recess region 412 in the O-ring 6 to enter the inside of the recess 5 at the end portion. This can suppress the movement of the O-ring 6 in the circumferential direction, that is, the rotation of the O-ring 6, in the state in which the pressure sensor 1 is attached to the casing 7 compared with the configuration in which the recess 5 is made around the whole circumference of the protrusion 42.

In the pressure sensor 1 in which the plurality of recesses 5 are made, the portion located on the non-recess region 412 in the O-ring 6 is pulled toward the recesses 5 in association with pressing of part of the O-ring 6 by the covering member 4 and the casing 7 and the entry of the part of the O-ring 6 into the inside of the recesses 5. At this time, if imbalance exists in the stretching of the O-ring 6 in the circumferential direction, a portion at which the stretching is large has a high possibility of breakage of the O-ring 6 compared with a portion at which the stretching is small. Moreover, at the portion at which the stretching is large, the width of the O-ring 6 becomes small and thus it becomes difficult for the O-ring 6 to come into contact with the outer wall surface 42a of the protrusion 42 or the inner wall surface 71c of the casing recess 71. This causes a risk of the lowering of the waterproof performance of the pressure sensor 1.

In the pressure sensor 1 according to the first embodiment, the plurality of recesses 5 are made at equal intervals in the circumferential direction of the protrusion 42 in plan view. Thus, the imbalance in the stretching of the O-ring 6 is suppressed. Due to this, the possibility of breakage of the O-ring 6 becomes lower than that in a configuration in which the plurality of recesses 5 are made at unequal intervals. Further, the width of the O-ring 6 is less likely to become small. Thus, the O-ring 6 easily comes into contact with the outer wall surface 42a of the protrusion 42 or the inner wall surface 71c of the casing recess 71. Therefore, the waterproof performance of the pressure sensor 1 can be kept more surely.

Moreover, in the pressure sensor 1 according to the first embodiment, the covering member 4 includes the main body 41 with a rectangular shape in plan view and the protrusion 42 with a circular shape in plan view. In plan view, the distance between a central portion of each side of the main body 41 and the protrusion 42 is shorter than the distance between each corner portion 411 of the main body 41 and the protrusion 42. Thus, if the recess 5 is made in a region between the central portion of each side of the main body 41 and the protrusion 42, the size of the main body 41 is likely to become larger in the surface direction of the upper surface 41b. On the other hand, in the configuration in which the recess 5 is made in the region between each corner portion 411 and the protrusion 42, the necessity to increase the size of the main body 41 for making the recess 5 is low. Therefore, size increase of the main body 41 in the above-described surface direction can be suppressed.

Further, in the pressure sensor 1 according to the first embodiment, the length of the recess 5 in the direction parallel to the width of the O-ring 6 is shorter than the width of the O-ring 6 in at least part of the recess 5. Thus, part of the O-ring 6 is not located in the recess 5 in the state in which the pressure sensor 1 is not attached to the casing 7. On the other hand, the O-ring 6 is pressed and deformed by the outer wall surface 42a of the protrusion 42 and the inner surface 71a of the casing recess 71 in the state in which the pressure sensor 1 is attached to the casing 7. At this time, the O-ring 6 enters the inside of the recess 5 only when the filling rate of the O-ring 6 in the disposition space for the O-ring 6 is high.

As described above, the O-ring 6 does not enter the inside of the recess when the filling rate of the O-ring 6 is low. Thus, the possibility of separation of the O-ring 6 from the outer wall surface 42a of the protrusion 42 and the inner surface 71a of the casing recess 71 can be reduced. On the other hand, when the filling rate of the O-ring 6 is high, part of the O-ring 6 enters the inside of the recess 5. This can suppress inhibition of attachment of the pressure sensor 1 to the casing 7 due to the O-ring 6. Therefore, it is possible to provide the pressure sensor 1 for which both the lowering of the waterproof performance and inhibition of attachment of the pressure sensor 1 to the casing 7 are suppressed.

Moreover, in the electronic equipment 100 according to the first embodiment, part of the O-ring 6 is located in the recesses 5. Thus, the electronic equipment 100 for which inhibition of attachment of the pressure sensor 1 to the casing 7 is suppressed can be implemented.

### Second Embodiment

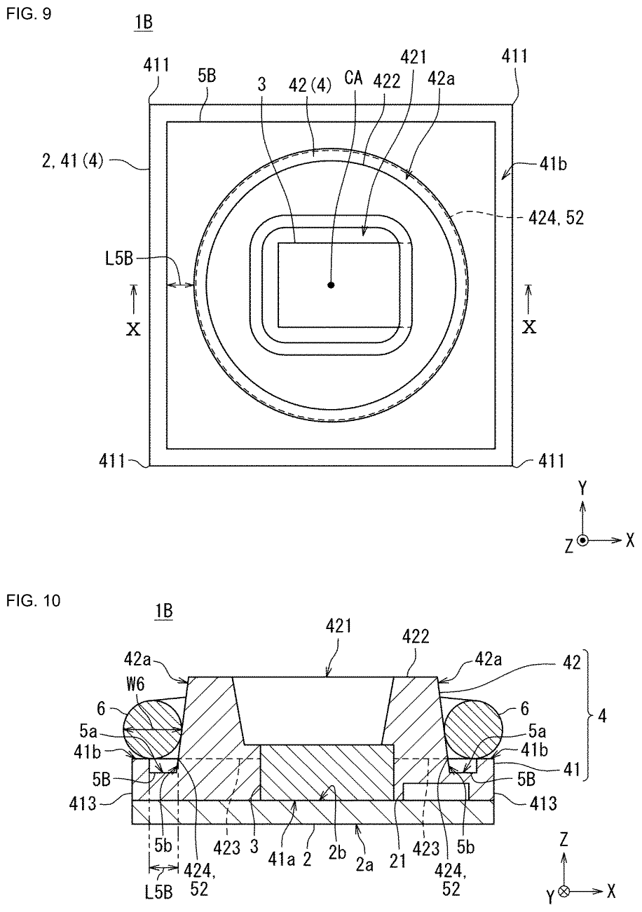

A pressure sensor according to a second embodiment of the present disclosure is described with reference to FIGS. 9 and 10. FIG. 9 is a plan view of the pressure sensor according to the second embodiment of the present disclosure. FIG. 10 is a sectional view of the pressure sensor of FIG. 9 along line X-X.

A pressure sensor 1B according to the second embodiment is different from the pressure sensor 1 according to the first embodiment in the shape and the size of a recess 5B. In the following description of the second embodiment, description is omitted concerning a configuration similar to that in the first embodiment.

As depicted in FIG. 9, in the pressure sensor 1B, the main body 41 has one recess 5B made in the upper surface 41b. The recess 5B is made around the whole circumference of the protrusion 42 in plan view. For example, the outer shape of the recess 5B is a circular shape, a polygonal shape, or the like. In the present embodiment, the outer shape of the recess 5B is a square similar to the outer shape of the substrate 2 and the main body 41. Further, the center of the recess 5B corresponds with the virtual central axis CA of the substrate 2, the main body 41, and the protrusion 42 in plan view.

The recess 5B has a length L5B of the recess 5B in the direction parallel to the width of the O-ring 6 (see FIG. 10). As depicted in FIG. 10, in the present embodiment, the O-ring 6 is disposed around the protrusion 42 similarly to the O-ring 6 in the first embodiment. Thus, the length L5B of the recess 5B is a length in the radiation direction from the virtual central axis CA.

As depicted in FIG. 9, the length L5B of the recess 5B is shortest in an XZ-section and a YZ-section including the virtual central axis CA in plan view. As depicted in FIG. 10, the length L5B of the recess 5B is shorter than the width W6 of the O-ring 6 in at least part of the recess 5B.

In the pressure sensor 1B according to the second embodiment, the recess 5B is made around the whole circumference of the protrusion 42 in plan view. Thus, when being pressed by the covering member 4 and the casing 7, the O-ring 6 is evenly disposed in the recess 5B across the whole circumference of the O-ring 6. Due to this, an upper portion of the O-ring 6 easily comes into contact with the bottom surface 71b of the casing recess 71 across the whole circumference of the O-ring 6 compared with a configuration in which the recess 5B is made around part of the protrusion 42 in the circumferential direction thereof. Therefore, the lowering of the waterproof performance of the pressure sensor 1B can be suppressed.

The present disclosure is not limited to the above-described embodiments, and can be carried out with other various aspects. For example, in the above description, the examples in which the pressure sensors 1, 1A, and 1B are provided with the O-ring 6 have been described. However, the pressure sensors 1, 1A, and 1B are not required to be provided with the O-ring 6.

Further, in the first embodiment, the four recesses 5 are formed into a congruent shape in plan view. However, the present disclosure is not limited thereto. For example, the shape of each recess 5 in plan view may be a circular shape, an elliptical shape, a polygonal shape, or the like. When the main body 41 has a plurality of recesses 5, the shapes of the recesses 5 in plan view may all be the same, or may be different from each other.

Moreover, in the above-described embodiment, the outer wall surface 42a of the protrusion 42 and the inner wall surfaces 5b of the recesses 5 are formed to be flush with each other. However, the present disclosure is not limited thereto. For example, even when the outer wall surface 42a and the inner wall surface 5b are formed as a continuous surface along the Z-direction, the inclination angle with respect to the XY-plane may differ between the outer wall surface 42a and the inner wall surface 5b. In addition, the outer wall surface 42a and the inner wall surface 5b are not required to be continuous. For example, the outer wall surface 42a may be connected to the inner wall surface 5b through the upper surface 41b of the main body 41.

Further, in the above-described embodiment, part of the O-ring 6 enters the inside of the recesses 5 when the O-ring 6 comes into contact with the bottom surface 71b of the casing recess 71. However, the present disclosure is not limited thereto. For example, part of the O-ring 6 may enter the inside of the recess 5 when the O-ring 6 is in contact with the outer wall surface 42a of the protrusion 42 and the inner wall surface 71c of the casing recess 71 and is not in contact with the bottom surface 71b of the casing recess 71.

By combining, as appropriate, any embodiments or modifications among the above-described various embodiments or modifications, effects that each embodiment or modification has can be provided. Further, a combination between embodiments, or a combination between examples, or a combination between an embodiment and an example is possible. In addition, a combination between features in different embodiments or examples is also possible.

Although the present disclosure is sufficiently described in relation to the preferred embodiments with reference to the accompanying drawings, various modifications and corrections are obvious for those skilled in the art. It should be understood that such modifications and corrections are included in the scope of the present disclosure based on the attached scope of claims as long as the modifications and the corrections are not out of the scope of the present disclosure.

The pressure sensor and the electronic equipment according to the present disclosure are useful as various pressure sensors because a defect in attachment to the casing is suppressed while the waterproof performance is kept.

### REFERENCE SIGNS LIST

1, 1A, 1B pressure sensor
2 substrate
3 detection element
4 covering member
41 main body
41b upper surface
411 corner portion
412 non-recess region
42a outer wall surface
421 exposure hole
423 lower end
424, 424A outer edge
5, 5A, 5B recess
51 opening
52 edge
6 O-ring
7 casing
71 casing recess
71a inner surface
100, 100A electronic equipment

1. A pressure sensor comprising:
a substrate;
a detection element on the substrate; and
a covering member on the substrate and defining an exposure hole that exposes at least part of the detection element to an outside, the covering member covering the detection element by a portion excluding the exposure hole, the covering member having:
a main body having an upper surface on an opposite side to a surface thereof facing the substrate, and
a protrusion that protrudes from the upper surface of the main body, the exposure hole extending through the protrusion,
the main body having at least one recess in the upper surface along the protrusion in a plan view as viewed in a thickness direction of the substrate and that hollows along the thickness direction, and
the at least one recess extends around at least part of the protrusion in a circumferential direction of the protrusion in the plan view.

2. The pressure sensor according to claim 1, wherein an outer edge of a lower end of the protrusion forms an edge of an opening of the recess.

3. The pressure sensor according to claim 2, wherein
the main body has the at least one recess around part of the protrusion in the circumferential direction of the protrusion in the plan view, and
the upper surface of the main body has a non-recess region adjacent to the protrusion and in which the recess is not present.

4. The pressure sensor according to claim 3, wherein the at least one recess comprises a plurality of recesses, and the main body has the plurality of recesses arranged at equal intervals in the circumferential direction of the protrusion in the plan view.

5. The pressure sensor according to claim 4, wherein
the main body has a rectangular shape having four corner portions in the plan view,
the protrusion has a circular shape in the plan view, and
each of the plurality of recesses is located between one of the four corner portions and the protrusion in the plan view.

6. The pressure sensor according to claim 5, wherein the plurality of recesses comprise four recesses.

7. The pressure sensor according to claim 1, wherein
the main body has the at least one recess around part of the protrusion in the circumferential direction of the protrusion in the plan view, and
the upper surface of the main body has a non-recess region adjacent to the protrusion and in which the recess is not present.

8. The pressure sensor according to claim 7, wherein the at least one recess comprises a plurality of recesses, and the main body has the plurality of recesses arranged at equal intervals in the circumferential direction of the protrusion in the plan view.

9. The pressure sensor according to claim 8, wherein
the main body has a rectangular shape having four corner portions in the plan view,
the protrusion has a circular shape in the plan view, and
each of the plurality of recesses is located between one of the four corner portions and the protrusion in the plan view.

10. The pressure sensor according to claim 9, wherein the plurality of recesses comprise four recesses.

11. The pressure sensor according to claim 1, wherein the at least one recess comprises a single recess, and the main body has the single recess extending around an entire circumference of the protrusion in the plan view.

12. The pressure sensor according to claim 1, wherein the main body has a first thickness between a lower surface of the main body and a bottom surface of the recess, the main body has a second thickness between the lower surface of the main body and the upper surface between an outer edge portion of the main body and the recess, and the second thickness is larger than the first thickness.

13. The pressure sensor according to claim 1, further comprising:
an O-ring that surrounds the protrusion in the plan view and is in contact with an outer wall surface of the protrusion, wherein
a length of the at least one recess in a direction parallel to a width of the O-ring is shorter than the width of the O-ring in at least part of the recess.

14. Electronic equipment comprising:
the pressure sensor according to claim 13; and
a casing having a casing recess constructed to receive the protrusion, wherein
the O-ring is in contact with an inner surface of the casing recess and the outer wall surface of the protrusion, and
a part of the O-ring is in the recess.

15. The electronic equipment according to claim 14, wherein an outer edge of a lower end of the protrusion forms an edge of an opening of the recess.

16. The electronic equipment according to claim 14, wherein
the main body has the at least one recess around part of the protrusion in the circumferential direction of the protrusion in the plan view, and
the upper surface of the main body has a non-recess region adjacent to the protrusion and in which the recess is not present.

17. The electronic equipment according to claim 16, wherein the at least one recess comprises a plurality of recesses, and the main body has the plurality of recesses arranged at equal intervals in the circumferential direction of the protrusion in the plan view.

18. The electronic equipment according to claim 17, wherein
the main body has a rectangular shape having four corner portions in the plan view,
the protrusion has a circular shape in the plan view, and
each of the plurality of recesses is located between one of the four corner portions and the protrusion in the plan view.

19. The electronic equipment according to claim 18, wherein the plurality of recesses comprise four recesses.

20. The electronic equipment according to claim 14, wherein the at least one recess comprises a single recess, and the main body has the single recess extending around an entire circumference of the protrusion in the plan view.
